(19) United States
(12) Patent Application Publication
(10) Pub. No.: US 2024/0393804 A1
(43) Pub. Date: Nov. 28, 2024

(54) METHOD FOR DETECTING AT LEAST ONE OBSTACLE IN AN AUTOMATED AND/OR AT LEAST SEMI-AUTONOMOUS DRIVING SYSTEM

(71) Applicants: ROBERT BOSCH GmbH, Stuttgart (DE); CARIAD SE, Wolfsburg (DE)

(72) Inventors: Denis Tananaev, Sindelfingen (DE); Niels Backfish, Hannover (DE)

(21) Appl. No.: 18/662,291

(22) Filed: May 13, 2024

(30) Foreign Application Priority Data
May 26, 2023 (DE) 10 2023 113 925.8

(51) Int. Cl. G05D 1/633; B60W 60/00; G05D 101/15; G06V 10/764; G06V 10/774; G06V 20/58; G06V 20/70

(52) U.S. Cl. CPC G05D 1/633; G06V 10/764; G06V 10/774; G06V 20/58; G06V 20/70; B60W 60/001; B60W 2420/403; G05D 2101/15

(57) ABSTRACT

The invention relates to method (100) for detecting at least one obstacle in an automated and/or at least semi-autonomous driving system (60), said method comprising the following steps:
providing (101) image data, wherein the image data are specific to a recording of an environment of the driving system (60),
performing (102) an evaluation of the image data provided, wherein the evaluation takes place based on an application of a machine learning model (50), by means of which an occlusion label is determined for at least one occlusion of the environment,
performing (103) the detection of the at least one obstacle on the basis of the occlusion label determined.

The present invention relates to a method for detecting at least one obstacle in an automated and/or at least semi-autonomous driving system. The invention further relates to a training method, a computer program, a device, a computer-readable storage medium, as well as a machine learning model.

### PRIOR ART

One of the most important challenges in perception by autonomous mobile robots or driver assistance systems is that of reliably detecting dangerous objects. The intention thereby is to enable reliable navigation in a 3D environment.

Conventional learning-based object recognition algorithms using convolutional neural networks (abbreviated as CNN) as a basis are often unable to learn a general representation of hazardous objects without being provided a sufficient number of human-annotated examples of all possible variants of said hazardous objects.

Given that manually labeling all of the possible generic objects is practically impossible, algorithms based on heuristics and deterministic formulations are often used to detect dangerous objects. One example of such an algorithm is presented by P. Pinggera, U. Franke, and R. Mester, “High-performance long range obstacle detection using stereo vision,” 2015 IEEE/RSJ International Conference on Intelligent Robots and Systems (IROS), Hamburg, Germany, 2015, pp. 1308-1313, doi: 10.1109/IROS.2015.7353537. Although this approach can indeed detect some unexpected obstacles, it often does not generalize to different scenarios and furthermore requires a stereo camera. However, many robotic systems use a mono camera.

### DESCRIPTION OF THE INVENTION

The object of the invention is a method having the features of claim 1, a training method having the features of claim 7, a computer program having the features of claim 8, a device having the features of claim 9, a computer readable storage medium having the features of claim 10, as well as a machine learning model having the features of claim 11. Further features and details of the invention follow from the dependent claims, the description, and the drawings. In this context, features and details which are described in connection with the method according to the invention are clearly also applicable in connection with the training method according to the invention, the computer program according to the invention, the device according to the invention, the computer-readable storage medium according to the invention, as well as the machine learning model according to the invention, and vice versa, so mutual reference is always made or may be made with respect to the individual aspects of the invention.

The object of the invention is in particular a method for detecting at least one obstacle in an automated and/or at least semi-autonomous driving system, said method comprising the following steps, which are preferably performed sequentially and/or repeatedly:
providing image data, the image data being specific to a recording of an environment around the driving system,
performing an evaluation of the image data provided, whereby the evaluation can be based on an application of a machine learning model, by means of which an occlusion label is determined for at least one occlusion of the environment,
performing the detection of the at least one obstacle, in particular a hazardous object, on the basis of the occlusion label determined.

The invention can have the advantage of overcoming the limitations of conventional learning-based approaches. This can specifically relate to the lack of availability of labeled data. According to the invention, instead of an immediate classification of hazardous objects, the occlusion label can in this case first be determined based on the image data—as an intermediate step—by means of machine learning. The invention can furthermore enable the training of a high-quality generic detector for hazardous objects that performs the detection based on the occlusion label determined. As will be described in greater detail hereinafter, self-supervised training using specific supervised elements can be used for this purpose. It can also be possible to reliably use the approach according to the invention not only in stereo cameras, but also in mono camera systems. In other words, the image data can comprise individual images instead of image sequences, so motion information can be omitted for the application of the machine learning model.

It is also advantageous for the training of the machine learning model to be based on determining an occlusion area on the basis of motion in a camera recording. An optical flow can for this purpose be estimated in a sequence of images resulting from the camera recording. The machine learning model can then be trained on the basis of the estimated optical flow to determine the occlusion label, in particular to determine the occlusion label only on the basis of image data in the form of a single image. The training can preferably be performed in the form of a self-supervised training process. The machine learning model can also be designed as a CNN. During training, the machine learning model can obtain an image sequence comprising two (or more) consecutive images as input from a monocular video and provide an estimation of the optical flow on this basis. Photometric error minimization can be used as a loss function. The occlusion area can refer to the spatial area which is occluded in the environment by the obstacle.

One special feature of the machine learning model training is that it can in particular take advantage of the fact that the optical flow is never able to detect all pixels when the camera is moving. This aspect can be used to either directly determine the occlusion label in the form of an obstacle map or to indirectly generate the occlusion label in the form of another type of obstacle map according to a “further loss option” described hereinafter. The occlusion label determined thereby can also be designed as an obstacle point cloud. Another special feature of the invention may be that the self-supervised training is able to rely upon large quantities of unlabeled data. In addition, bounding boxes can optionally be created from the obstacle point cloud, and a false positive reduction classifier can be run on the detected object candidates during a further phase.

Within the scope of the invention, it is also conceivable that the image data (in particular in inference mode) comprise at least one or exactly one individual image which results from a recording using a monocular or stereo camera. In other words: After a training process as described hereinabove, exactly one individual image can be usable in inference mode. Preferably, the image data used for the machine learning model as input for determining the occlusion label are limited to the individual image. In other words, the machine learning model does not require movement information as input for determining, preferably generating, the occlusion label.

It can optionally be provided that the occlusion label is specific to the at least one occlusion and/or is designed as a occlusion map which identifies at least one or multiple areas in the image data that are occluded by at least one object in the environment. The occlusion map can in this case also be designed as an occlusion mask which, e.g., indicates (preferably in a binary manner) for individual elements such as pixels of the image data whether they are occluded by at least one object.

Within the scope of the invention, it can preferably be provided that the detection of (the) at least one obstacle comprises an evaluation of the occlusion label, preferably by means of a classifier and preferentially a classifier trained by means of machine learning, during which evaluation a classification of one of the objects, which is in the form of a hazardous object associated with the respective occlusion and detected in the image data, is performed in reference to the occlusion label. The hazardous object can in particular be cargo that has fallen from a truck. In addition, the hazardous object can also be referred to as an object that may be potentially hazardous to a moving vehicle and/or a robot comprising the driving system. The classifier can be restricted to determining whether the object is a hazardous object. A classification into further classes can therefore be omitted, and the classifier can therefore be designed in a class-agnostic manner.

It can also be optionally provided that, based on the evaluation and/or detection, at least partially autonomous control of an ego vehicle and/or a robot is performed by the driving system, preferably by a motion planning system. The driving system can, e.g., be designed as a driver assistance system or an autonomous driving system for, e.g., use in autonomous mobile robots or autonomous vehicles. A perception system can in this case provide a representation of the 3D environment, and this representation can be used as input into a motion planning system, which then decides how the ego vehicle should be maneuvered.

The object of the invention is also a training method for training a machine learning model, said method comprising:
providing training data, whereby the training data comprise at least one sequence of images representing an environment of a driving system during a trip, and the training data can further comprise annotation data, in particular in the form of ground truth, which indicate an occlusion label representing at least one occlusion of the environment during the trip,
performing training of the machine learning model in reference to the training data, during which training an optical flow in the sequence of images is taken into account in order to predict the occlusion label.

The training method according to the invention thereby provides the same advantages as described in detail with regard to a method according to the invention for detecting at least one obstacle. The machine learning model applied in the method according to the invention for detecting at least one obstacle can in this case preferably result from the training method according to the invention. The object of the invention is also the machine learning model which is obtained by the training method according to the invention.

Regarding the training method, it is also conceivable that an essential matrix be calculated based on the estimated optical flow and the occlusion label in the form of a occlusion map that indicates (the) at least one occlusion and preferably a calibration matrix of the camera. A 3D point triangulation and/or depth estimation can be performed as another step. In reference to the relative transformations between two images of the image sequence, triangulation can be applied in order to obtain 3D points for each point correspondence from the optical flow.

The object of the invention is also a computer program, in particular a computer program product comprising instructions that, when the computer program is executed by a computer, prompt the latter to perform the method according to the invention. The computer program according to the invention thereby provides the same advantages as described in detail with regard to a method according to the invention.

The object of the invention is also a device for data processing, which is configured to perform the method according to the invention. For example, a computer can be provided as the device that executes the computer program according to the invention. The computer can comprise at least one processor for executing the computer program. A non-volatile data storage means can also be provided, in which the computer program is stored and from which the computer program can be read by the processor for execution.

The object of the invention can also be a computer-readable storage medium comprising the computer program according to the invention and/or comprising instructions that, when executed by a computer, prompt the latter to perform the method according to the invention. The storage medium is, e.g., designed as a data storage means such as a hard disk, and/or a non-volatile memory, and/or a memory card. The storage medium can, e.g., be integrated into the computer.

The method according to the invention can furthermore be designed as a computer-implemented method.

Further advantages, features, and details of the invention follow from the description hereinafter, in which embodiments of the invention are described in detail with reference to the drawings. In this context, each of the features mentioned in the claims and in the description may be essential to the invention, whether on their own or in any combination. Shown are:

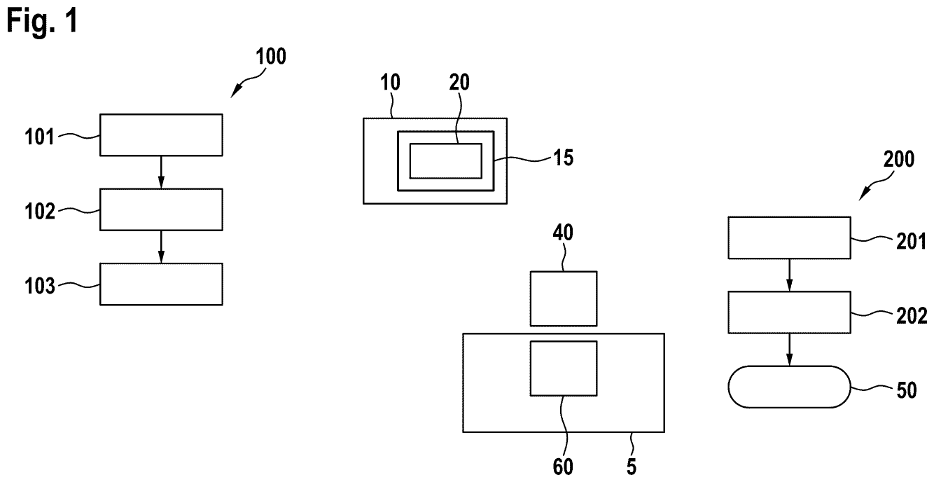

FIG. 1a schematic illustration of a method, a device, a storage medium, a machine learning model, a training method, as well as a computer program according to exemplary embodiments of the invention.

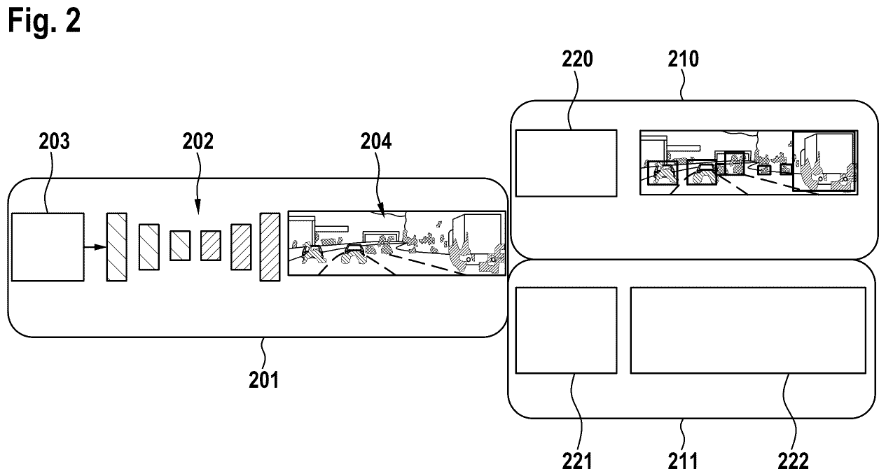

FIG. 2a further schematic drawing for illustrating a training method according to exemplary embodiments of the invention.

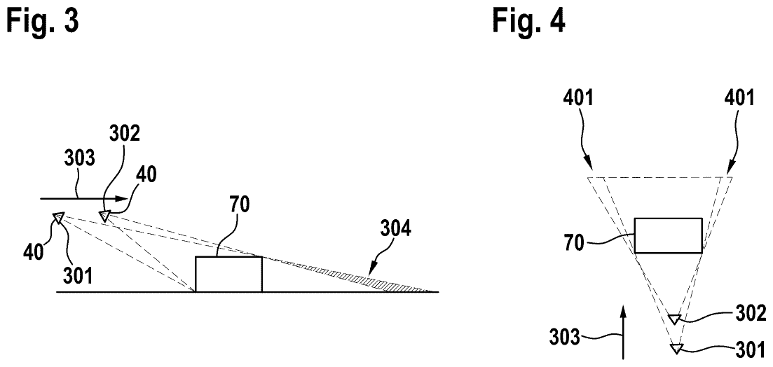

FIG. 3 an illustration of a determination of the occlusion label with a monocular camera in motion.

FIG. 4a further illustration of a determination of the occlusion label with the monocular camera in motion.

Schematically shown in FIG. 1 are a method 100, a device 10, a storage medium 15, as well as a computer program 20 according to exemplary embodiments of the invention. It is in this case shown that, in the method 100 for detecting at least one obstacle in an automated and/or at least semi-autonomous driving system 60, image data can first be provided according to a first method step 101. The image data can be specific to a recording of an environment of the driving system 60. According to a second method step 102, an evaluation of the image data can then be provided, whereby the evaluation takes place based on an application of a machine learning model 50, by means of which an obscuration label is determined for at least one occlusion of the environment. In a third method step 103, the at least one obstacle can subsequently be detected based on the occlusion label determined. Furthermore, based on the evaluation and/or detection, at least partially autonomous control of an ego vehicle 5 and/or a robot 5 can be performed by the driving system 60, preferably by a motion planning system.

FIGS. 2 to 4 further illustrate that a training of the machine learning model 50 can be based on an occlusion area 304, 401 being determined on the basis of a movement 303 in a camera recording, whereby an optical flow is preferably estimated for this purpose in a sequence of images resulting from the camera recording, and the machine learning model 50 is trained in reference to the estimated optical flow (preferably referred to as overall loss L_o) in order to determine the occlusion label, the training preferably being performed in the form of a self-supervised training process. It is also possible for an occlusion area to be determined by calculating the best possible normals describing the pixels (represented by L_repr). The latter occlusion label can also be obtained from stereo images. The occlusion label can in this case be specific to the at least one occlusion and preferably be designed as a occlusion map which identifies at least one or multiple areas in the image data that are occluded by at least one object 70 in the occluded area 304, 401 in the environment.

Also illustrated in FIG. 1 is a training method 200 for training a machine learning model 50, in which method the training data are provided according to a first training step 201, and the training of the machine learning model 50 is provided according to a second training step 202 in order to predict the occlusion label. The trained machine learning model 50 can be obtained in this way.

Exemplary embodiments of the invention can have the advantage of providing a trainable algorithm without the need for a large amount of labeled data. Although it is relatively straightforward to collect large amounts of unlabeled data, the processing and marking of these data for use in supervised algorithms such as CNN-based object recognition is quite expensive and, given an unknown number of objects (e.g., hazardous objects), it is nearly or entirely possible. According to exemplary embodiments of the invention, an algorithm can in this case be provided which is also suitable for mono camera setups. In contrast to deterministic algorithms, the learning-based algorithms according to exemplary embodiments of the invention can be adaptable. In other words, they can be trained to solve problem cases by the addition of data. On the other hand, this adaptation and training of difficult situations not known before the initial publication and application of the algorithm are impossible using non-learning-based approaches. Exemplary embodiments of the invention can thereby be suitable for both stereo cameras and mono cameras.

Exemplary embodiments can enable detection of hazardous objects in order to enable the navigation of autonomous systems. The creation of HD maps can also be enabled.

In advanced driver assistance systems or autonomous driving systems, the perception system provides a representation of the 3D environment, and this representation is used as input into a motion planning system, which then decides how the ego vehicle should be maneuvered. A key aspect of the perception system technology consists of recognizing where the vehicle can drive and what the environment around the automobile looks like. Conventional computer vision technologies are known which are often not sufficiently robust because they are unable to learn in the way that machine learning technologies do. In contrast, learning-based methods provide excellent results, but require a large number of labels, i.e., manual annotation of data. Exemplary embodiments of the invention employ high-quality learning-based approaches and can solve the labeling problem by self-supervised pretraining, as a result of which the required number of data annotations is significantly reduced. Self-supervised training can in this case be based on a training method in connection with machine learning or artificial intelligence, whereby the model learns from unlabeled data by comparing its own predictions with actual results and learning from this process without relying on manually annotated data. In semi-supervised training, however, the model is trained using both labeled data and unlabeled data in order to achieve improved performance and the ability to generalize.

A semi-supervised generic algorithm for obstacle detection as shown in FIG. 2 can be designed as follows. Self-supervised training 201 of a CNN 202 can be performed first. The training can in this case comprise at least one of the following steps:
a self-supervised CNN training process for the optical flow,
a calculation of an occlusion mask based on the optical flow calculated,
an estimate of an essential matrix,
a 3D point triangulation and depth estimation, and
training a single-image occlusion CNN.

The essential matrix can in this case be a matrix which is calculated based on the pixel correspondence between two camera images. The matrix describes the relationship between the camera positions in this way and enables reconstruction of the position of an object in three-dimensional space. Calculation of the essential Matrix is, e.g., performed by using algorithms such as RANSAC (Random Sample Consensus) or the introduction of constraints (e.g., epipolar geometry).

Illustrated in FIG. 2 are, e.g., a camera image 203 (in the RGB color model in particular) and an occlusion mask 204. Supervised tuning 210 of the algorithm 220 based on machine learning or deep learning techniques or DBScan-based clustering 221 can then be performed. A reduction 222 in false positive results can subsequently be provided by a supervised classifier that processes each candidate obstacle.

Self-supervised pretraining of the CNN can be provided during a first phase. This phase makes it possible for the lack of labeled data in relation to all possible hazardous objects to be overcome. The operating principle will be clarified hereinafter. Every elevated object results in occlusions (see FIG. 3). Therefore, a CNN 202 can be trained to detect occlusions in a self-supervised manner (see FIG. 2) because the occlusions have high-quality features as well as areas of interest, where hazardous objects may be located. A CNN can be trained using a sequence of successive images from a monocular camera 40 or stereo camera 40 by minimizing photometric loss between the images in order to obtain optical flow and maximize occlusion loss in order to obtain an occlusion detector. The input for this first phase is, e.g., video sequences from a monocular camera 40 and the calibration matrix. Shown in the side view according to FIG. 3 are two chronologically sequential camera positions 301, 302, which change as a result of the movement 303 of the driving system 60. Further shown and illustrated is an obstacle 70. By virtue of movement 303, an upper region 304 of the occlusion can be determined by the obstacle 70. FIG. 4 shows a top view of the obstacle 70, with the two camera positions 301, 302 also illustrated. It is also shown that, by virtue of movement 303 of the driving system 60, a side area 401 of the occlusion can also be determined.

Self-supervised training of the optical flow can be provided by exemplary embodiments of the invention. In other words, training of the self-supervised optical flow CNN can be performed in a first step. The CNN can for this purpose obtain two (or more) consecutive images as input from a monocular video and provide an estimation of the optical flow on this basis. Photometric error minimization can be used as a loss function:

$${L}_{p} = {\sum }_{{t}^{′}} O \cdot pe ( {I}_{t} , {I}_{{t}^{′} \to t} )$$

The element-by-element multiplication is represented by·, O is the occlusion mask, and It′→t=InverseWarp(opticalflowt→t′, It′) is the distorted image from the source image It′ to the target image It when using optical flow. The photometric loss is:

$$pe ( {I}_{t} , {I}_{{t}^{′} \to t} ) = \frac{a}{2} ( 1 - S S I M ( {I}_{t} , {I}_{{t}^{′} \to t} ) ) + ( 1 - a ) {‖ {I}_{t} - {I}_{{t}^{′} \to t} ‖}_{1}$$

where SSIM is the structural similarity. An edge-conscious smoothing flow can likewise be applied:

$${L}_{smooth} = \vert {\partial }_{x} opticalflow \vert {e}^{- \vert {\partial }_{x} I \vert} + \vert {\partial }_{y} opticalflow \vert {e}^{- \vert {\partial }_{y} I \vert}$$

The smoothing loss provides a smoothing of the optical flow in homogeneous areas of the image and enables flow changes at the edges. The total loss is represented by:

$$L = {w}_{1} * {L}_{p} + {w}_{2} * {L}_{smooth}$$

In this context, w1, w2 are the weighting for the loss components, and opticalflowt→t′ is the optical flow from the target image It to the source image It′. When calculating an occlusion mask, a CNN can further be used to calculate the opposite optical flow opticalflowt→t′ (from the source image to the target) as follows:

$$V ( x , y ) = {\sum }_{i = 1}^{W} {\sum }_{j = 1}^{H} max ( 0 , 1 - \vert x - {opticalflow}_{{t}^{′} \to t}^{x} ( i , j ) \vert ) * max ( 0 , 1 - \vert y - {opticalflow}_{{t}^{′} \to t}^{y} ( i , j ) \vert )$$

where V(x, y) is an area map at the location (x, y) on the image at the height H and the width W, and opticalflowt′→t x opticalflow t′→t y are the horizontal or vertical optical flow components. An occlusion map, which is also referred to as an occlusion label, can be determined by threshold generation as follows:

$$0 = min ( 1 , V ( x , y ) )$$

In this case, the occlusion map has soft values between 0 and 1, where 0 means that the image is occluded, and 1 means that it is not occluded.

The essential matrix can then be estimated. Using the optical flow and occlusion masks from the previous steps, as well as the calibration matrix K of the camera, the essential matrix E can be estimated and the relative rotation R and translation B between the images determined by means of the essential matrix breakdown algorithm. The essential matrix describes the relationships between the pixels in two images under a given coplanarity condition as follows:

$${k}^{} {x}^{′T} {E}^{k} {x}^{″} = 0$$

resulting in: kx′T=x′T(K′)−T
x′T is the k-th transposed pixel position vector from the first image, and (K′)−T is the inverse and transposed calibration matrix of the first image,
resulting in: kx″=(K″)−1 x″
x″ is the k-th pixel position vector from the second image, and (K″)−1 is the inverse calibration matrix of the second image. In order to estimate the essential matrix E, a five-point algorithm can be used which consists of determining five corresponding points on two images and solving the resulting constrained optimization problem in the form of a least squares formula. Given that the optical flow may contain many outliers, all of the hidden points can be masked first and RANSAC used to deal with outliers.

A 3D point triangulation and/or depth estimation can be performed as another step. Triangulation can be applied in reference to the relative transformations between two images in order to obtain 3D points for each point correspondence from the optical flow. The triangulation can be initialized using a two-vector intersection solution in closed form, and the reprojection error can then be minimized using the least squares method.

In reference to the relative transformations between the images, the calibration, the occlusion masks and the triangulated depth, the individual image occlusion CNN can be trained as follows: The network can receive individual images as input, or it can work on a stereo image and then a binary mask for occluded objects, which is a vector field of normals [symbol] to the plane, in which each point forms a narrow environment Ω with the surrounding points, and output a depth estimate. The trust mask can be trained in a supervised manner by using the binary cross-entropy loss and the occlusion mask from the optical flow as ground truth.

$${L}_{o} = binaryCrossEntropy ( prediction , O )$$

The prediction in this case is the prediction of the CNN in the range [0, 1], where 1 means no occlusion and 0 is occluded. O describes the occlusion mask from the optical flow, where 1 is not occluded and 0 is occluded. The depth of occluded objects can also be learned using the L1 loss.

$${L}_{d} = {‖ d - \hat{d} ‖}_{1}$$

where d is the predicted disparity, and \hat{d} is the actual disparity. The depth can be calculated as Depth=1.0/d and the surface normal to elevated objects can be calculated by first calculating the homography:

$${H}_{i} = K ( R - \frac{1}{g} \vec{b} {\vec{{n}_{t}}}^{T} ) {K}^{- 1}$$

where H is the homography, K is the calibration matrix, g is the scaling factor, [symbol] is the translation vector, and [symbol] is the vector normal to the surface plane at location i∈Pos, and where Pos refers to all spatial locations in the vector field generated by the CNN. The position of a plane at position i can be identified using θᵢ=( [symbol] ᵢ, dᵢ), where dᵢ is the depth at the position i. There are, e.g., two options for defining a loss function. The first option aims to directly regress the surface normal [symbol] , whereby it is disregarded whether an obstacle or a street surface is in question. The smoothed L1 loss can be used in this case:

$${L}_{repr} = {\sum }_{𝔦 ∈ Pos} {\sum }_{j ∈ Ω} {‖ HomographyWarp ( I ( j ) , {Θ}_{i} ) - I ( j ) ‖}_{1}$$

where HomographyWarp distorts part of the image with homography, and I is the original image.

In reference to the angle of the calculated normals n, an estimate can then be calculated at each point regarding whether a hazardous object is located at this point. This is in particular performed when the angle exceeds a specific angle g. An obstacle map or point cloud can be generated in this way.

The second option is more complicated, but it provides the advantage of creating an additional obstacle point cloud by means of hypothesis testing. In this option, the CNN returns two vector fields: [symbol] _{f}, which represents the street level or open space and [symbol] ₒ, which represents the surface of an object. The loss calculation is complicated because a ground truth or a decision about which normal vector is the “correct” one must be provided. This is true because the loss is only intended to be added to the contribution of the “correct” normal vector. To do this in an unsupervised manner, the “street level/open space” label f can be used if:

$${\sum }_{j ∈ Ω} {‖ HomographyWarp ( I ( j ) , {Θ}_{i}^{f} ) - I ( j ) ‖}_{1} \geq {\sum }_{j ∈ Ω} {‖ HomographyWarp ( I ( j ) , {Θ}_{i}^{o} ) - I ( j ) ‖}_{1}$$

Given this classification, the additional (second) loss option can be expressed as follows:

$${L}_{repr} = {\sum }_{𝔦 ∈ Pos} {\sum }_{j ∈ Ω} {1}_{i has label f} {‖ HomographyWarp ( I ( j ) , {Θ}_{i}^{f} ) - I ( j ) ‖}_{1} + {1}_{i has label o} {‖ HomographyWarp ( I ( j ) , {Θ}_{i}^{o} ) - I ( j ) ‖}_{1}$$

An obstacle point cloud can be created based on a ratio hypothesis test for this additional (second) loss option:

$$\frac{{\sum }_{j ∈ Ω} {‖ HomographyWarp ( I ( j ) , {Θ}_{i}^{o} ) - I ( j ) ( Θ ) ‖}_{1}}{{\sum }_{j ∈ Ω} {‖ HomographyWarp ( I ( j ) , {Θ}_{i}^{f} ) - I ( j ) ( Θ ) ‖}_{1}} \geq γ$$

where γ is a threshold value calibrated in reference to a validation dataset and describes whether the point is considered an object or obstacle. The total loss can be defined as:

$$L = {w}_{1} {L}_{o} + {w}_{2} {L}_{d} + {w}_{3} {L}_{repr}$$

A supervised option and a mixed solution comprising supervised elements can therefore be obtained for the second step.

The solution 210 shown in FIG. 2 in particular employs supervised fine-tuning of the resulting CNN for occlusion recognition from the first phase. A machine learning classifier can be trained in a supervised manner in order to learn classification of self-supervised features for the individual 2D boxes. This classifier can be a SVM, a logistic regression, or a CNN-based head for learning a direct classification between occlusions and 2D objects in the image. The CNN can be trained in a class-independent manner, meaning that only one “obstacle” class exists.

The second solution 211, which is also shown in FIG. 2, in particular uses the occlusion points generated during the first phase and performs clustering on the basis of DBScan using an R-tree. The outermost points of the cluster define bounding boxes of obstacle objects. This post-processing can be the same as in the following publication: P. Pinggera, U. Franke, and R. Mester, “High-performance long range obstacle detection using stereo vision,” 2015 IEEE/RSJ International Conference on Intelligent Robots and Systems (IROS), Hamburg, Germany, 2015, pp. 1308-1313, doi: 10.1109/IROS.2015.7353537. Small classifiers can run on the bounding box region, e.g., a CNN or a fully networked neural network as a mechanism for reducing false alarms. This classifier can be fully trained under supervision and comprises more classes than that of just “obstacle.”

The foregoing explanation of the embodiments describes the present invention solely within the scope of examples. Insofar as technically advantageous, specific features of the embodiments may obviously be combined at will with one another without departing from the scope of the present invention.

1. A method for detecting at least one obstacle in an automated and/or at least semi-autonomous driving system, said method comprising the following steps:
providing image data, wherein the image data are specific to a recording of an environment of the driving system, performing an evaluation of the image data provided, wherein the evaluation takes place based on an application of a machine learning model, by means of which an occlusion label is determined for at least one occlusion of the environment, performing the detection of the at least one obstacle on the basis of the occlusion label determined.

2. The method according to claim 1, characterized in that
training of the machine learning model is based on an occlusion area being determined on the basis of a movement in a camera recording, wherein an optical flow is preferably estimated for this purpose in a sequence of images resulting from the camera recording, and the machine learning model is trained in reference to the estimated optical flow in order to determine the occlusion label, wherein the training is preferably performed in the form of a self-supervised training process.

3. The method according to claim 1, characterized in that
the image data, in particular in inference mode, comprise at least one or exactly one individual image, which results from a recording by means of a monocular or stereo camera, wherein the image data used for the machine learning model as input for determining the occlusion label are preferably limited to the individual image.

4. The method according to claim 1, characterized in that
the occlusion label is specific to the at least one occlusion and is preferably designed as a occlusion map which identifies at least one or multiple areas in the image data that are occluded by at least one object in the environment.

5. The method according to claim 1,
characterized in that
the detection of the at least one obstacle comprises an evaluation of the occlusion label, preferably by means of a classifier, during which evaluation a classification of one of the objects, which is in the form of a hazardous object associated with the respective occlusion and detected in the image data, is performed in reference to the occlusion label, wherein the hazardous object in particular comprises cargo that has fallen from a truck.

6. The method according to claim 1, characterized in that, based on the evaluation and/or detection, at least partially autonomous control of an ego vehicle and/or a robot is performed by the driving system, preferably by a motion planning system.

7. A training method for training a machine learning model, said method comprising:
providing training data, wherein the training data comprise at least one sequence of images representing an environment of a driving system during a trip, wherein the training data further comprise annotation data which indicate an occlusion label representing at least one occlusion of the environment during the trip,
performing training of the machine learning model on the basis of the training data, during which training an optical flow in the sequence of images is taken into account in order to predict the occlusion label.

8. A computer program comprising instructions which, when the computer program is executed by a computer, prompt the latter to:
provide image data, wherein the image data are specific to a recording of an environment of the driving system,
perform an evaluation of the image data provided, wherein the evaluation takes place based on an application of a machine learning model, by means of which an occlusion label is determined for at least one occlusion of the environment, and
perform the detection of the at least one obstacle on the basis of the occlusion label determined.

9. A device for data processing, which is configured to:
provide image data, wherein the image data are specific to a recording of an environment of the driving system,
perform an evaluation of the image data provided, wherein the evaluation takes place based on an application of a machine learning model, by means of which an occlusion label is determined for at least one occlusion of the environment, and
perform the detection of the at least one obstacle on the basis of the occlusion label determined.

10. A non-transitory computer-readable storage medium comprising instructions which, when executed by a computer, prompt the latter to perform the method according to
provide image data, wherein the image data are specific to a recording of an environment of the driving system,
perform an evaluation of the image data provided, wherein the evaluation takes place based on an application of a machine learning model, by means of which an occlusion label is determined for at least one occlusion of the environment, and
perform the detection of the at least one obstacle on the basis of the occlusion label determined.

11. A non-transitory computer-readable storage medium comprising instructions which, when executed by a computer, prompt the latter to;
provide training data, wherein the training data comprise at least one sequence of images representing an environment of a driving system during a trip, wherein the training data further comprise annotation data which indicate an occlusion label representing at least one occlusion of the environment during the trip,
performing training of a machine learning model on the basis of the training data, during which training an optical flow in the sequence of images is taken into account in order to predict the occlusion label.
